(19) United States
(12) Patent Application Publication
(10) Pub. No.: US 2023/0399110 A1
(43) Pub. Date: Dec. 14, 2023

(54) APPARATUS AND METHOD FOR AIRFLOW MODIFICATION IN VEHICLES

(71) Applicant: Pexco Aerospace, Inc., Union Gap, WA (US)

(72) Inventors: Boney Mathew, Union Gap, WA (US); Aaron Bitz-Richards, Union Gap, WA (US); Fernando Coronel, Union Gap, WA (US); Chris Howard, Union Gap, WA (US); Jon Page, Union Gap, WA (US); John Ponce, Union Gap, WA (US)

(73) Assignee: Pexco Aerospace, Inc., Union Gap, WA (US)

(21) Appl. No.: 18/067,037

(22) Filed: Dec. 16, 2022

Related U.S. Application Data
(60) Provisional application No. 63/351,074, filed on Jun. 10, 2022.

(51) Int. Cl. B64D 13/00; B64D 11/00; A62B 7/14

(52) U.S. Cl. CPC B64D 13/00; B64D 11/0015; B64D 2013/003; B64D 2011/0053; A62B 7/14

(57) ABSTRACT

Provided is a passenger service unit for an aircraft. The passenger service unit includes a panel body having a first surface, a second surface opposite the first surface, and at least two air passages extending through the panel body, at least one light controllable by a passenger, and at least two air vents extending from the first surface of the panel body at respective fixed angles, each of the at least two air vents configured to receive air from a respective one of the at least two air passages.

### RELATED APPLICATIONS

This application claims the benefit of U.S. Provisional Application No. 63/351,074 filed Jun. 10, 2022, which is hereby incorporated herein by reference.

### FIELD OF INVENTION

The present invention relates generally to airflow modification, and more particularly to an apparatus for modifying airflow in an aircraft cabin.

### BACKGROUND

Airborne disease transmission increases in densely packed aircraft cabins due to the aerosolization of infectious agents that disperse widely and remain in the air for varying periods, depending on environmental conditions. Although most modern aircraft cabins are equipped with High-Efficiency Particulate Air (HEPA) filters, the path of exhaled aerosol droplets contributes to the potential for virus spread before reaching the air outlets and passing through the HEPA filters. Passengers seated within close proximity of an infected passenger are at increased risk of airborne pathogen transmission.

### SUMMARY OF INVENTION

According to an aspect, a passenger service unit is provided that includes a panel body having a first surface, a second surface opposite the first surface, and at least two air passages extending through the panel body, at least one light controllable by a passenger, and at least two air vents extending from the first surface of the panel body at respective fixed angles, each of the at least two air vents configured to receive air from a respective one of the at least two air passages.

The at least two air vents may be integrally formed with the panel body.

Each of the at least two air vents may include a pair of fins, and wherein each fin is substantially parallel to the other fin in the respective pair of fins.

The at least two air vents may include a first air vent extending from the first surface at a first angle and a second air vent extending from the first surface at a second angle, and the first and second angles may be supplementary angles.

The at least one light may include a first light, a second light, and a third light, the at least two air passages may include a first air passage, a second air passage, a third air passage, and a fourth air passage, and the at least two air vents may include a first air vent, a second air vent, a third air vent, and a fourth air vent.

The first and second air vents may be on opposite sides of the first light, the second and third air vents may be on opposite sides of the second light, and the third and fourth air vents may be on opposite sides of the third light.

The first, second, and third lights and the first, second, third, and fourth air vents may be aligned in a first direction along a plane of the panel body.

The first, second, and third lights may be aligned in a first direction along a plane of the body, and the first, second, third, and fourth air vents may be aligned in the first direction and offset from the first, second and third lights in a second direction substantially perpendicular to the first direction.

The first air vent, second air vent, third air vent, and fourth air vent may extend from the first surface at a first angle, a second angle, a third angle, and a fourth angle respectively, the first and fourth angles may be supplementary angles, and the second and third angles may be supplementary angles.

The first and second angles may be obtuse, the first angle may be greater than the second angle, and the third angle may be greater than the fourth angle.

The passenger service unit panel may further include a plenum coupled to the second surface of the panel body surrounding the at least two air passages, wherein the plenum may include an inlet configured to be coupled to a hose for receiving air to be directed to the at least two air passages.

The panel body may include a projection projecting from the second surface around the at least two air passages, and the plenum may be coupled to the projection.

The panel body may further include at least one light casing for receiving the at least one light, and the plenum may surround the at least one light casing.

The passenger service unit panel may further include a wire connector for connecting to wires connected to the at least one light, wherein the plenum includes a slot through which the wire connector extends.

The passenger service unit panel may further include at least one interface control extending from the first surface of the panel body, at least one passenger notification indicator on the first surface of the panel body, at least one speaker coupled to the panel body, and at least one oxygen mask panel coupled to the panel body.

According to another aspect, a passenger service unit panel may include a panel body having a first surface and a second surface opposite the first surface, a first light, a second light, and a third light, and a first air vent, a second air vent, a third air vent, and a fourth air vent, each air vent extending from the first surface of the panel body at a respective fixed angle, wherein the first and second air vents are on opposite sides of the first light, the second and third air vents are on opposite sides of the second light, and the third and fourth air vents are on opposite sides of the third light.

The first, second, and third lights and the first, second, third, and fourth air vents may be aligned in a first direction along a plane of the panel body.

The first, second, and third lights may be aligned in a first direction along a plane of the body, and the first, second, third, and fourth air vents may be aligned in the first direction and offset from the first, second and third lights in a second direction substantially perpendicular to the first direction.

According to still another aspect, a passenger service unit panel may include a panel body having a first surface and a second surface opposite the first surface, at least two lights, at least one interface control at the first surface of the panel body for controlling the at least two lights, at least one passenger notification indicator at first surface of the panel body, at least one speaker coupled to the panel body, at least one oxygen mask panel coupled to the panel body, and at least three air vents extending from the first surface of the panel body at respective fixed angles.

The at least two lights and the at least three air vents may be aligned in a first direction along a plane of the panel body.

The foregoing and other features of the application are described below with reference to the drawings.

### BRIEF DESCRIPTION OF THE DRAWINGS

FIG. 1 is a perspective view of an exemplary airflow assembly.

FIG. 2 is another perspective view of the airflow assembly.

FIG. 3 is a cross-sectional view of the airflow assembly taken about line 3-3 in FIG. 5.

FIG. 4 is a cross-sectional view of the airflow assembly taken about line 4-4 in FIG. 5.

FIG. 5 is a top view of the airflow assembly.

FIG. 6 is a bottom view of the airflow assembly.

FIG. 7 is a perspective view of a panel of the airflow assembly.

FIG. 8 is another perspective view of the panel.

FIG. 9 is a perspective view of an exemplary Passenger Service Unit panel.

FIG. 10 is another perspective view of the Passenger Service Unit panel.

FIG. 11 is a bottom view of the Passenger Service Unit panel.

FIG. 12 is a top view of the Passenger Service Unit panel.

FIG. 13 is a cross-sectional view of the Passenger Service Unit panel taken about line 13-13 in FIG. 10.

FIG. 14 is a perspective view of the Passenger Service Unit panel with a plenum removed.

FIG. 15 is a perspective view of the plenum.

FIG. 16 is a bottom view of another exemplary Passenger Service Unit panel.

### DETAILED DESCRIPTION

The principles of the present application relate to modifying airflow in an aircraft cabin and thus will be described below in this context. It will be appreciated that the principles of the application may be applicable to modifying airflow in other vehicles and spaces, such as buses, trains, waiting rooms, etc.

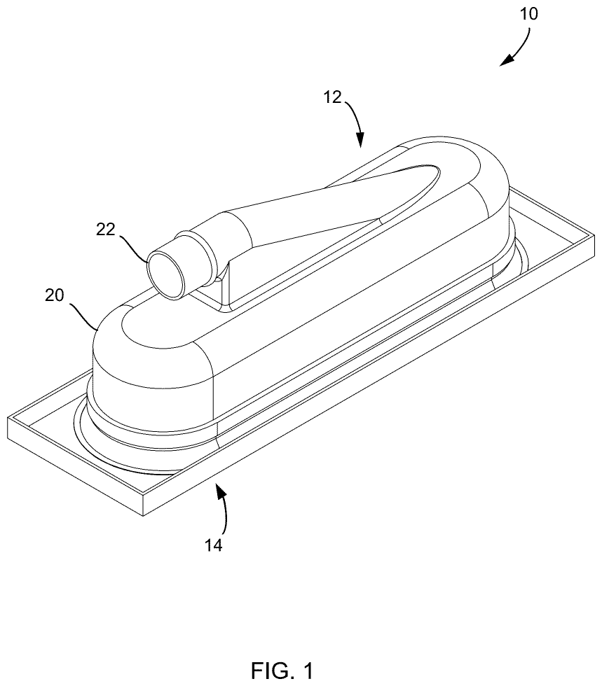

Turning initially to FIG. 1, an exemplary airflow assembly is illustrated at reference numeral 10. The airflow assembly can be integrated into a Passenger Service Unit (PSU), either as a new assembly or a retrofit, for example replacing a traditional gasper assembly providing air to each seat in a row of the aircraft cabin. The airflow assembly 10 includes an air distributor 12 configured to be coupled to a gasper hose of the aircraft, and a panel 14 attached to the air distributor 12. The panel 14 may be attached to the PSU or ceiling of the aircraft in a suitable manner, such as with one or more fasteners.

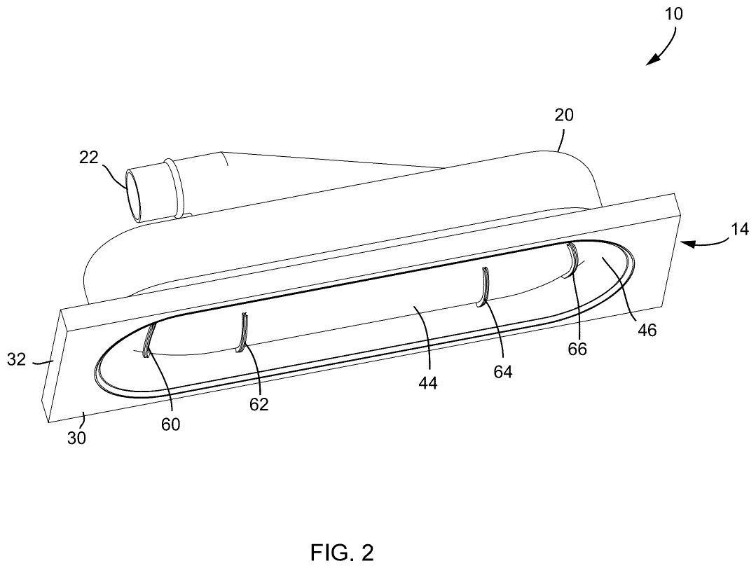

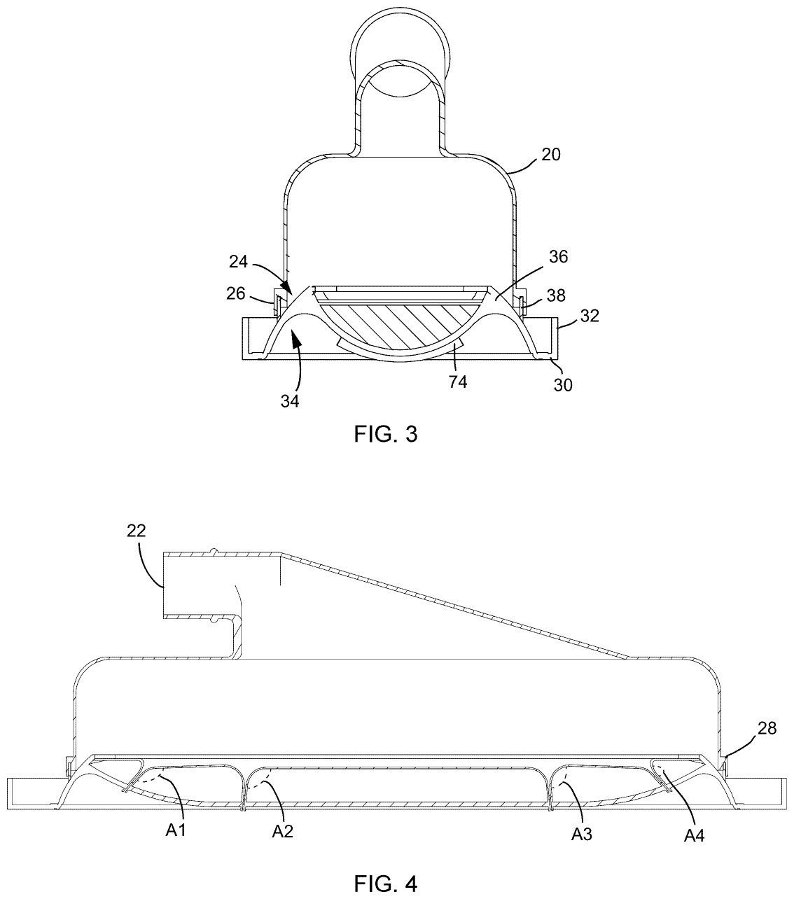

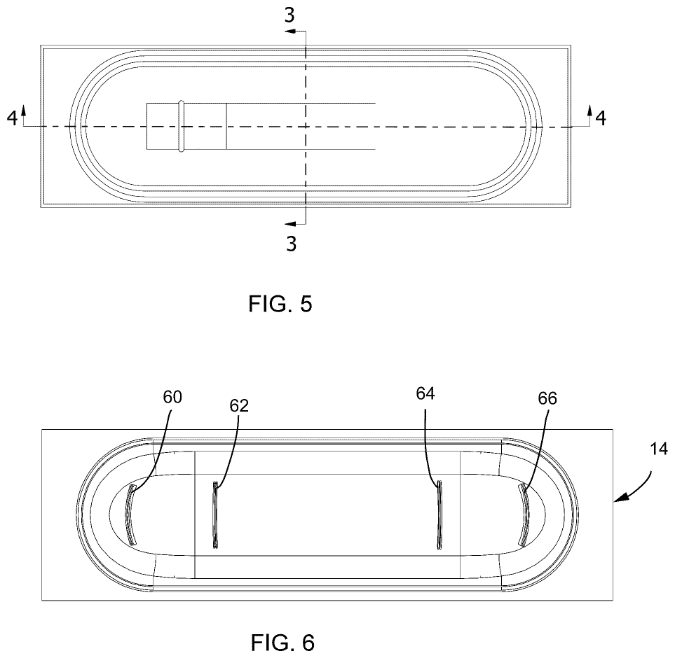

Turning additionally to FIGS. 2-6, the air distributor 12, which is shown as being transparent but may be opaque for example, includes a body 20 having an inlet 22 configured to be coupled to the gasper hose and an outlet 24 formed at a bottom of the air distributor 12 for distributing air along a length of the air distributor 12 to deliver air to various outlets in the panel 14. The air distributor 12 also includes a projection 26 projecting outward from a side of the body 20 and downward below a bottom of the body 20 to define with the body 20 a slot 28 for connecting to the panel 14. The slot 28 may extend around a perimeter of the air distributor 12 for sealing to the panel 14. In an embodiment, a gasket or other suitable sealing device may be provided in the slot 28 for sealing the air distributor 12 to the panel 14.

Referring now to the panel 14 in detail, the panel 14 includes a base 30, an outer projection 32 extending upward from the base 30 around a perimeter thereof, and a central projection 34 projecting from the base 30 around which the air distributor 12 is received. The central projection 34 includes an inwardly curved wall 36 extending upward from the base 30 and a projection 38 extending upward from and around a periphery of the inwardly curved wall 36. The projection 38 is received in the slot 28 of the air distributor 12, and the air distributor 12 and the panel 14 may be coupled in a suitable manner, such as by adhesive, welding, etc. The central projection 34 also includes an air outlet region 40 having an upper surface 42 toward which the air from the air distributor 12 is directed, and a lower curved surface 44 extending downward toward the base 30. A cavity 46 is formed between the base 30, the curved wall 36, and the lower curved surface 44 such that the lower curved surface 44 is recessed relative to the base 30 to maintain the appearance of the aircraft interior. The profile of the panel 14 also serves to reduce noise caused by air flowing from the air distributor 12 and through the panel 14.

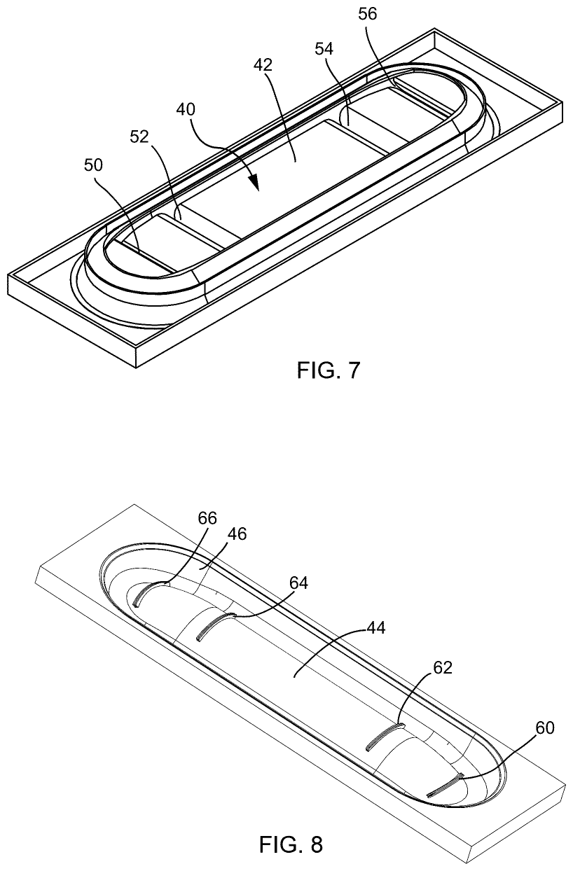

Turning additionally to FIGS. 7 and 8, the air outlet region 40 includes one or more air passages extending therethrough from the upper surface 42 to the lower curved surface 44. The upper surface 42 may include respective curved surfaces forming an inlet end of each of the one or more air passages. For example, the upper surface 42 may include two converging curved surfaces that form each inlet end.

As shown, the air outlet region 40 includes a plurality of the air passages, for example four air passages 50, 52, 54, and 56. The air passages 50, 52, 54, and 56 each have an outlet end that directs air to respective air vents 60, 62, 64, and 66 that direct the air to predetermined positions in the cabin to create laminar air curtains. As shown, the air vents 60 and 66 are outwardly angled at a first angle A1 and a second angle A2 respectively relative to a line extending along a plane of the base 30 to direct the air outwardly and downwardly, and the air vents 62 and 64 are outwardly angled at a third angle A3 and a fourth angle A4 respectively to direct the air substantially downwardly. The first and second angles A1 and A2 may be supplementary angles (angles with a sum of one hundred eighty degrees) or substantially supplementary angles, and the third and fourth angles A3 and A4 may be supplementary angles or substantially supplementary. As shown, the first angle A1 and the third angle A3 are obtuse and the second angle A2 and the fourth angle A4 are acute, where the first angle A1 is larger than the third angle A3 and the fourth angle A4 is larger than the second angle A2. As shown, the second and third angles A2 and A3 may be similar to direct air substantially downward.

For example, the air vent 60 may direct the air downwardly at the first angle to create an air curtain between a window seat passenger and a wall of the aircraft, the air vent 62 may direct the air downwardly at the third angle to create an air curtain between a middle seat passenger and the window seat passenger, the air vent 64 may direct air downwardly at the fourth angle to create an air curtain between the middle seat passenger and an aisle passenger, and the air vent 66 may direct air downwardly at the second angle to create an air curtain between the aisle seat passenger and the aisle.

As noted above, the airflow assembly 10 can be installed during new installation or as a retrofit to a traditional gasper assembly. Once installed, the airflow assembly will be integrated in the PSU to provide a visible safety cue to passengers without detracting from the cabin design, and provide laminar air curtains to provide for predetermined airflow within the cabin.

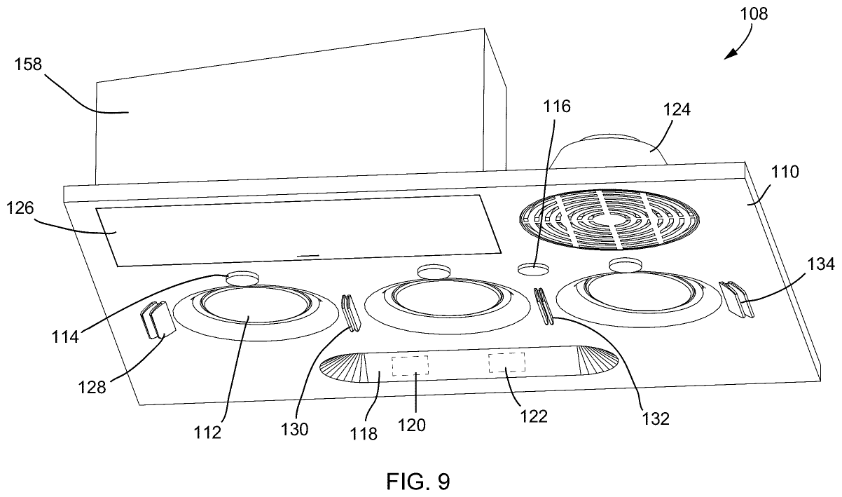

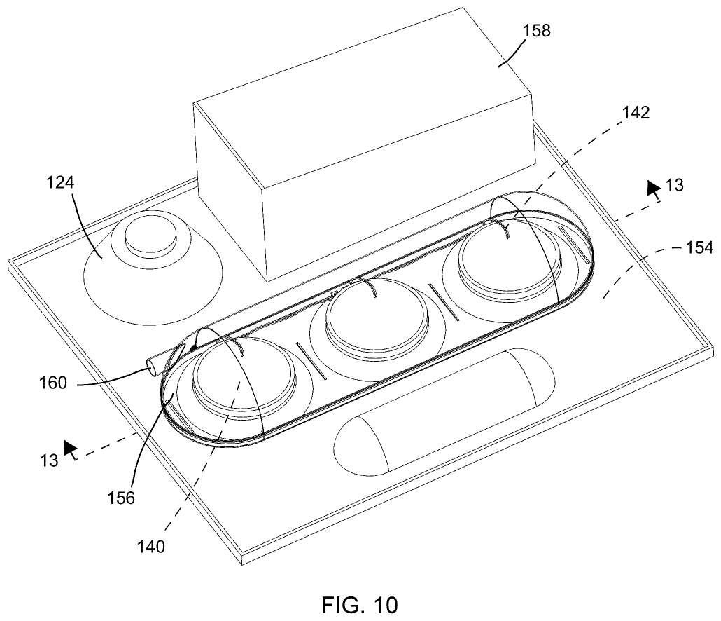

Turning now to FIGS. 9 and 10, an exemplary PSU panel is illustrated at reference numeral 108. The PSU panel 108 can be integrated into an aircraft either as a new assembly or a retrofit, for example replacing a traditional PSU panel to provide the functionality associated with a PSU panel while providing the below described air curtains for passengers. The PSU panel 108 may be attached to the ceiling of the aircraft in a suitable manner, such as with one or more fasteners, and may be made of a suitable material such as an amorphous thermoplastic polyetherimide (PEI) resin that provides flame resistance, low smoke emission, high strength, and broad chemical resistance. In an embodiment, the PEI may be an antimicrobial PEI. It will be appreciated that the PSU panel may be made of other suitable materials, such as polycarbonate, polyurethane, thermoplastic polyurethane, polymer blends, etc.

The PSU panel 108 includes a panel body 110 having a first surface and a second surface opposite the first surface, one or more lights 112 recessed in the first surface, one or more passenger interface controls on the first surface, such as a light control 114 and an attendant-call control 116, a recessed area 118 recessed in the first surface having a display for passenger notification indicators, such as a no-smoking indicator 120 and a fasten seatbelt indicator 122, a speaker 124 coupled to the panel body 110, an oxygen mask panel 126 coupled to the panel body, and one or more air vents 128-134 extending from the first surface at fixed angles. The PSU panel 108 may include one light 112 per passenger, and as shown three lights 112a, 112b, and 112c, a light control 114 per light 112, and a plurality of air vents, such as air vents 128, 130, 132, and 134. The air vents 128-134 may be coupled to the panel body 110 in a suitable manner, or integrally formed as shown. In another example, for example in an aircraft configuration with two seats, the PSU panel 108 may include two lights and three air vents.

The PSU panel 108 includes a light casing 140 encasing each light 112, wires 142 connected to each light 112, and a wire connector 144 to which the wires 142 are connected. The light casings 140 may be coupled to the body 110 in a suitable manner or may be integrally formed with the body as shown forming a recessed areas for receiving each light 112. The lights 112 may be movable relative to the panel body 110 by a passenger to adjust the direction of the light, and the light casings 140 include a curved profile to not disrupt airflow through the panel 108.

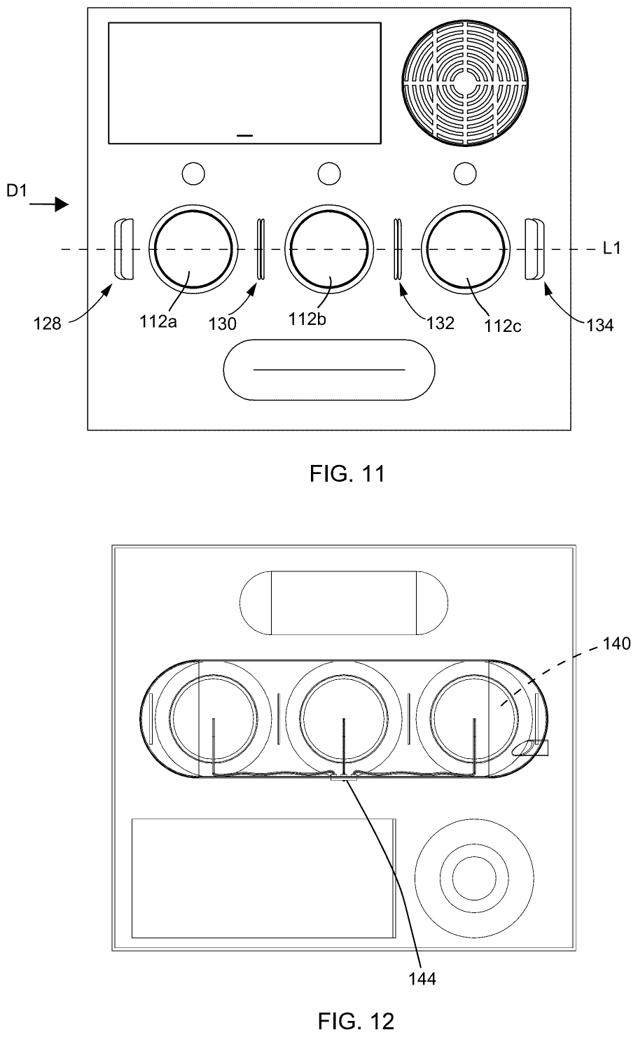

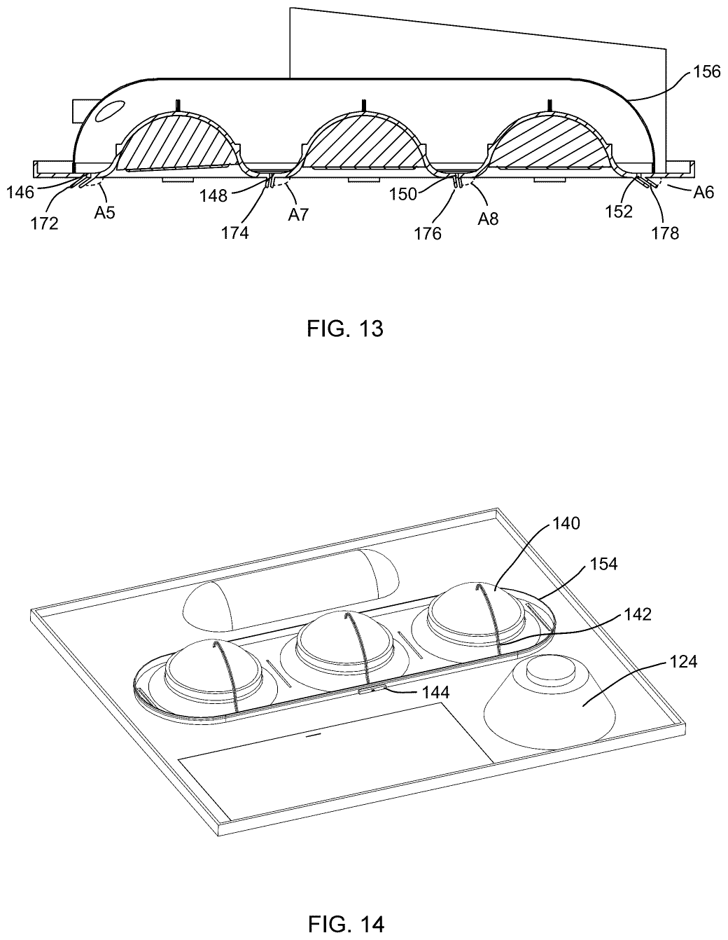

Turning additionally to FIGS. 11-14, the PSU panel 108 also includes an air passage 146, 148, 150, and 152 through the body 110 corresponding to each air vent 128-134, a projection 154 protecting upward from a rear of the panel body 110 around the light casings 140, wires 142, and the air passages 146-152, a plenum 156 coupled to the projection 154, and an oxygen mask casing 158. The oxygen mask casing 158 may be coupled to the panel body 110 in a suitable manner or integrally formed with the panel body 110.

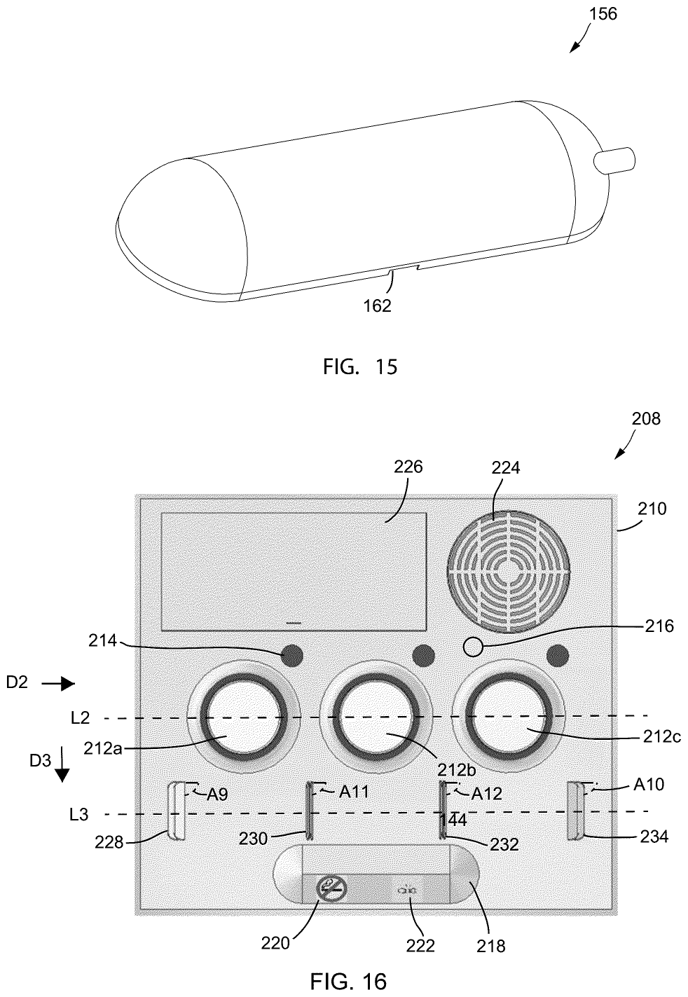

Turning additionally to FIG. 15, the plenum 156, which is shown as being transparent but may be opaque for example, may be coupled to the projection 154 in a suitable manner, such as by a snap fit connection. In an embodiment, sealant or a suitable seal may be provided between the plenum 156 and the projection 154 to prevent airflow between the projection 154 and plenum 156. The plenum 156 includes an inlet 160 configured to be coupled to the gasper hose in a suitable manner, and a slot 162 through which the wire connector 144 extends to allow for electrical connection to the wire connector 144 and for maintenance of the lights 112. The wire connector 144 and plenum 156 may be sealed to one another in a suitable manner. The plenum 156 is coupled to the projection 154 enclosing the light casings 140, the wires 142, and the air passages 146-152 and includes a curved profile for directing the airflow from the inlet 160 to the air passages 146-152.

Air flows into the plenum 156 though the inlet 160 and to each air passage 146, 148, 150, and 152, where it then exits the PSU panel 108 through the air vents 128, 130, 132, and 134. The air vents 128-134 may each be formed by a pair of fins 170-176 respectively, where each fin is parallel or substantially parallel to the other fin in the respective pair of fins to direct the air from the air passages 146-152 at predetermined angles. As shown, the air vents 128-134 are provided on each side of each light 112 and aligned with the plurality of lights 112 in a first direction D1 along a plane of the panel body 110. For example, the air vents 128 and 130 are on opposite sides of the light 112a, the air vents 130 and 132 are on opposite sides of the light 112b, and the air vents 132 and 134 are on opposite sides of the light 112c. As shown in FIG. 11, the air vents 128-134 and the lights 112a-c are aligned along a line L1 such that the line L1 extends through centers of the air vents 128-134 and the lights 112a-c. By aligning the air vents 128-134 and the lights 112, space is conserved on the PSU panel 108 while providing for the accessibility of all features.

The air vents 128-134 are angled at fixed angles to direct air to predetermined positions in the cabin creating laminar air curtains. The air vents 128 and 134 are outwardly angled at a fifth angle A5 and a sixth angle A6 respectively relative to a line extending along a plane of the panel body 110 to direct the air outwardly and downwardly, and the air vents 130 and 132 are outwardly angled at a seventh angle A7 and an eighth angle A8 respectively to direct the air substantially downwardly. The fifth and sixth angles A5 and A6 may be supplementary angles or they may be substantially supplementary angles, and the seventh and eighth angles A7 and A8 may be supplementary angles or they may be substantially supplementary. As shown, the fifth angle A5 and the seventh angle A7 are obtuse and the sixth angle A6 and the eighth angle A8 are acute, where the fifth angle A5 is larger than the seventh angle A7 and the eighth angle A8 is larger than the sixth angle A6. As shown, the seventh and eighth angles A7 and A8 may be similar to direct air substantially downward. For example, the air vent 128 may direct the air downwardly at the fifth angle A5 to create an air curtain between a window seat passenger and a wall of the aircraft, the air vent 130 may direct the air downwardly at the seventh angle A7 to create an air curtain between a middle seat passenger and the window seat passenger, the air vent 132 may direct air downwardly at the eighth angle A8 to create an air curtain between the middle seat passenger and an aisle passenger, and the air vent 134 may direct air downwardly at the sixth angle A6 to create an air curtain between the aisle seat passenger and the aisle.

Turning now to FIG. 16, an exemplary embodiment of the PSU panel is shown at 208. The PSU panel 208 is substantially the same as the above-referenced PSU panel 108, and consequently the same reference numerals but indexed by 100 are used to denote structures corresponding to similar structures in the PSU panels. In addition, the foregoing description of the PSU panel 108 is equally applicable to the PSU panel 208 except as noted below.

The PSU panel 208 includes a panel body 210, one or more lights on its front and as shown three lights 212a-212c, one or more passenger interface controls, such as a light control 214 and an attendant-call control 216, a recessed area 218 having a display for passenger notification indicators, such as a no-smoking indicator 220 and a fasten seatbelt indicator 222, a speaker 224, an oxygen mask panel 226, and one or more air vents 228, 230, 232, and 234.

Air flows into a plenum though an inlet and to each of a plurality of air passages corresponding to a respective one of the air vents 228-234, and then exits the PSU panel 208 through the air vents 228-234. As shown, the three lights 212a-212c are aligned in a second direction D2 along a plane of the body and the air vents 228-234 are aligned in the second direction D2 but offset from the lights 212a-212c in a third direction D3 substantially perpendicular to the second direction D2 so as to be parallel to the lights. For example, the lights 212a-c are aligned along a line L2 such that the line L2 extends through centers of the lights 212a-c and the air vents 228-234 are aligned along a line L3 parallel to line L2 such that line L3 extends through centers of the air vents 228-234. The air vents 228-234 may be provided on each side of each light 212 but offset in the third direction. By offsetting the air vents 228-134 and the lights 212, the plenum can be provided over the air passages and the light casings and wires can be provided outside the plenum.

The air vents 228-234 are angled at fixed angles to direct air to predetermined positions in the cabin creating laminar air curtains. The air vents 228 and 234 are outwardly angled at a ninth angle A9 and a tenth angle A10 respectively relative to a line extending along a plane of the panel body 210 to direct the air outwardly and downwardly, and the air vents 230 and 232 are outwardly angled at a eleventh angle A11 and a twelfth angle A12 respectively to direct the air substantially downwardly. The ninth and tenth angles A9 and A10 may be supplementary angles or they may be substantially supplementary angles, and the eleventh and twelfth angles A11 and A12 may be supplementary angles or they may be substantially supplementary. As shown, the ninth angle A9 and the eleventh angle A11 are obtuse and the tenth angle A10 and the twelfth angle A12 are acute, where the ninth angle A9 is larger than the eleventh angle A11 and the twelfth angle A12 is larger than the tenth angle A10. As shown, the eleventh and twelfth angles A11 and A12 may be similar to direct air substantially downward. For example, the air vent 228 may direct the air downwardly at the ninth angle A9 to create an air curtain between a window seat passenger and a wall of the aircraft, the air vent 230 may direct the air downwardly at the eleventh angle A11 to create an air curtain between a middle seat passenger and the window seat passenger, the air vent 232 may direct air downwardly at the twelfth angle A12 to create an air curtain between the middle seat passenger and an aisle passenger, and the air vent 234 may direct air downwardly at the tenth angle A10 to create an air curtain between the aisle seat passenger and the aisle.

Although certain embodiments have been shown and described, it is understood that equivalents and modifications falling within the scope of the appended claims will occur to others who are skilled in the art upon the reading and understanding of this specification.

1. A passenger service unit (PSU) panel comprising:
a panel body having a first surface, a second surface opposite the first surface, and at least two air passages extending through the panel body;
at least one light controllable by a passenger; and
at least two air vents extending from the first surface of the panel body at respective fixed angles, each of the at least two air vents configured to receive air from a respective one of the at least two air passages.

2. The PSU panel according to claim 1, wherein the at least two air vents are integrally formed with the panel body.

3. The PSU panel according to claim 1, wherein each of the at least two air vents includes a pair of fins, and wherein each fin is substantially parallel to the other fin in the respective pair of fins.

4. The PSU panel according to claim 1, wherein the at least two air vents includes a first air vent extending from the first surface at a first angle and a second air vent extending from the first surface at a second angle, and wherein the first and second angles are supplementary angles.

5. The PSU panel according to claim 1, wherein the at least one light includes a first light, a second light, and a third light, wherein the at least two air passages includes a first air passage, a second air passage, a third air passage, and a fourth air passage, and wherein the at least two air vents includes a first air vent, a second air vent, a third air vent, and a fourth air vent.

6. The PSU panel according to claim 5, wherein the first and second air vents are on opposite sides of the first light, the second and third air vents are on opposite sides of the second light, and the third and fourth air vents are on opposite sides of the third light.

7. The PSU panel according to claim 5, wherein the first, second, and third lights and the first, second, third, and fourth air vents are aligned in a first direction along a plane of the panel body.

8. The PSU panel according to claim 5, wherein the first, second, and third lights are aligned in a first direction along a plane of the body, and wherein the first, second, third, and fourth air vents are aligned in the first direction and offset from the first, second and third lights in a second direction substantially perpendicular to the first direction.

9. The PSU panel according to claim 5, wherein the first air vent, second air vent, third air vent, and fourth air vent extend from the first surface at a first angle, a second angle, a third angle, and a fourth angle respectively, wherein the first and fourth angles are supplementary angles, and wherein the second and third angles are supplementary angles.

10. The PSU panel according to claim 9, wherein the first and second angles are obtuse, wherein the first angle is greater than the second angle, and wherein the third angle is greater than the fourth angle.

11. The PSU panel according to claim 1, further comprising a plenum coupled to the second surface of the panel body surrounding the at least two air passages, wherein the plenum includes an inlet configured to be coupled to a hose for receiving air to be directed to the at least two air passages.

12. The PSU panel according to claim 11, wherein the panel body includes a projection projecting from the second surface around the at least two air passages, and wherein the plenum is coupled to the projection.

13. The PSU panel according to claim 11, wherein the panel body further includes at least one light casing for receiving the at least one light, and wherein the plenum surrounds the at least one light casing.

14. The PSU panel according to claim 11, further comprising a wire connector for connecting to wires connected to the at least one light, wherein the plenum includes a slot through which the wire connector extends.

15. The PSU panel according to claim 1, further comprising at least one interface control extending from the first surface of the panel body, at least one passenger notification indicator on the first surface of the panel body, at least one speaker coupled to the panel body, and at least one oxygen mask panel coupled to the panel body.

16. A passenger service unit (PSU) panel comprising:
a panel body having a first surface and a second surface opposite the first surface;
a first light, a second light, and a third light; and
a first air vent, a second air vent, a third air vent, and a fourth air vent, each air vent extending from the first surface of the panel body at a respective fixed angle,
wherein the first and second air vents are on opposite sides of the first light, the second and third air vents are on opposite sides of the second light, and the third and fourth air vents are on opposite sides of the third light.

17. The PSU panel according to claim 16, wherein the first, second, and third lights and the first, second, third, and fourth air vents are aligned in a first direction along a plane of the panel body.

18. The PSU panel according to claim 16, wherein the first, second, and third lights are aligned in a first direction along a plane of the body, and wherein the first, second, third, and fourth air vents are aligned in the first direction and offset from the first, second and third lights in a second direction substantially perpendicular to the first direction.

19. A passenger service unit (PSU) panel comprising:
a panel body having a first surface and a second surface opposite the first surface;
at least two lights;
at least one interface control at the first surface of the panel body for controlling the at least two lights;
at least one passenger notification indicator at first surface of the panel body;
at least one speaker coupled to the panel body;
at least one oxygen mask panel coupled to the panel body; and
at least three air vents extending from the first surface of the panel body at respective fixed angles.

20. The PSU panel according to claim 19, wherein the at least two lights and the at least three air vents are aligned in a first direction along a plane of the panel body.
